(19) United States
(12) Patent Application Publication
(10) Pub. No.: US 2020/0189617 A1
(43) Pub. Date: Jun. 18, 2020

(54) Vehicle Control Device

(71) Applicant: Hitachi, Ltd., Chiyoda-ku, Tokyo (JP)

(72) Inventors: Nahoko TAKADA, Tokyo (JP); Shinji NAKAGAWA, Tokyo (JP)

(21) Appl. No.: 16/640,571

(22) PCT Filed: Aug. 29, 2017
(86) PCT No.: PCT/JP2017/030884

§ 371 Date: Feb. 20, 2020

(51) Int. Cl. B60W 60/00; G05D 1/00; B60W 50/14

(52) U.S. Cl. CPC B60W 60/0053; G05D 1/0061; B60W 50/14; B60W 2050/146; B60W 60/0021; B60W 2540/221; B60W 60/0023

(57) ABSTRACT

The present invention appropriately switches from autonomous driving to manual driving. A vehicle control device according to the present invention switches between autonomous driving and manual driving of a vehicle, and includes a first step of obtaining traveling route candidates of the vehicle, a second step of acquiring information that is at least one of information on an operation performed by a user at switching from the autonomous driving to the manual driving and biometric information on the user, and a third step of selecting a traveling route of the vehicle based on the information acquired in the second step.

### TECHNICAL FIELD

The present invention relates to a vehicle control device for automatically traveling a route selected from a plurality of route candidates to a destination.

### BACKGROUND ART

A market involving the use of autonomous mobile bodies such as autonomous vehicles is drawing high expectations. A destination a travel distance for which is long may be reached by multiple routes.

Due to the development of big data, artificial intelligence, and machine learning, demands for personal tailoring of control contents based on learning of characteristics of each user have been growing in the field of automatic control devices such as robots. For diverse service use environments, it is difficult to determine the completion of learning of user information with a test case and a time until completion of the learning determined in advance.

Many currently available autonomous driving systems determine that autonomous driving is dangerous under a complicated environment or when a sensor failure occurs, and thus switch to manual driving. PTL 1 discloses an example of a technique for reducing switching to manual driving. Specifically, the number of times of switching to manual driving and a distance traveled by manual driving are calculated for each route, based on past traveling data. Then, a longer route involving a smaller number of times of switching to manual driving or a route with a shorter manual driving travel distance can be selected.

### CITATION LIST

### Patent Literature

PTL 1: JP 2015-141050 A

### SUMMARY OF INVENTION

### Technical Problem

However, with the conventional technology, there is a possibility that manual driving might be resumed in a complicated surrounding environment.

### Solution to Problem

Therefore, according to the present invention, a vehicle control device switches between autonomous driving and manual driving of a vehicle, and includes a first step of obtaining traveling route candidates of the vehicle, a second step of acquiring information that is at least one of information on an operation performed by a user at switching from the autonomous driving to the manual driving and biometric information on the user, and a third step of selecting a traveling route of the vehicle based on the information acquired in the second step.

### Advantageous Effects of Invention

With the present invention, switching from autonomous driving to manual driving can be appropriately performed.

### BRIEF DESCRIPTION OF DRAWINGS

FIG. 1 is a control block diagram according to an embodiment of the present invention.

FIG. 2 is a configuration diagram of a control device according to an embodiment of the present invention.

FIG. 3 is a diagram for explaining calculation of switchability in a first embodiment.

FIG. 4 is a diagram for explaining calculation of switchability in the first embodiment different from FIG. 3.

FIG. 5 is a flowchart according to the embodiment of the present invention.

FIG. 6 is a diagram for explaining calculation of switchability using biometric information.

FIG. 7 is a diagram for explaining another example of calculation of switchability using biometric information.

FIG. 8 is a diagram illustrating behavior according to the embodiment of the present invention.

FIG. 9 is a diagram for explaining calculation of switchability using a time until switching to manual driving.

FIG. 10 is a diagram for explaining calculation of switchability in a second embodiment.

FIG. 11 is a diagram for explaining calculation of switchability in the second embodiment different from FIG. 11.

FIG. 12 is a control block diagram for extracting and using data close to a user.

FIG. 13 is a configuration diagram of a control device that extracts and uses data close to a user.

FIG. 14 is a diagram for explaining that autonomous driving is determined to have been stopped safely.

### DESCRIPTION OF EMBODIMENTS

Now, embodiments of the present invention will be described in detail with reference to the drawings. It should be noted that the present invention is not limited to the following embodiments, and includes various modifications and application examples without departing from the technical concept of the present invention. In an embodiment of the present invention, individual (user) characteristics are learned with data on an operation amount, an external environment condition, and internal environment information collected while a user is performing manual operation in an actual environment. Then, a progress of the individual characteristic learning is determined for each scene, and individual adaptive control is executed stepwise accordingly.

### First Embodiment

As a first embodiment, an example of a route selection method in an autonomous vehicle will be described. The present embodiment particularly relates to a vehicle control device that selects a route according to an intention and preference of a user of an autonomous mobile body.

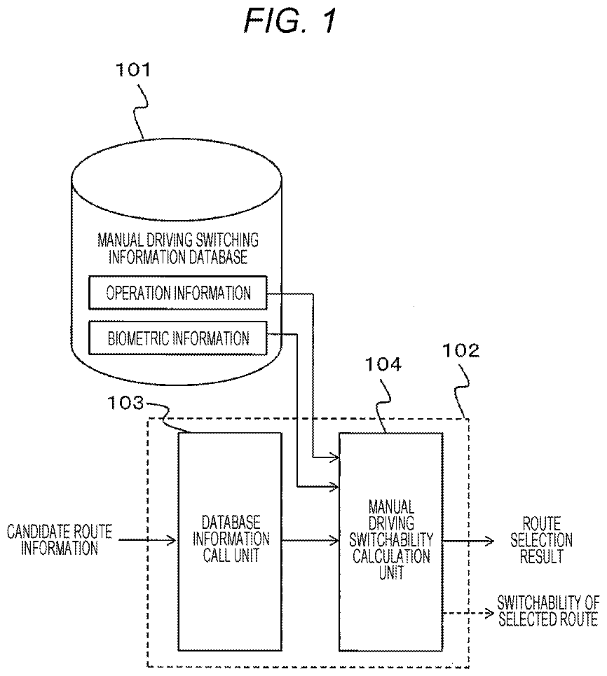

FIG. 1 is a control block diagram according to an embodiment of the present invention. A manual driving switching information database 101 stores all information that was acquirable and is any of vehicle position information at the time of occurrence of an event for switching from autonomous driving to manual driving in the past and operation information or biometric information on a user that are acquired through C2X communications and the like.

The operation information includes at least one of: an operation by the user affecting any of a traveling direction and moving speed of the vehicle (examples of which include a steering angle, an accelerator position, a brake depression amount, a stick controller tilt amount, and a speed or traveling direction setting amount set by using a button and the like); a control command value for such values during the autonomous driving before switching to the manual driving; and a time required for switching from the autonomous driving to the manual driving to be completed (a time point t0 when the system side determines to perform switching of the driving and a time point t1 when a switching notification is issued. It should be noted that values of the traveling direction and the moving speed per se may be stored and used instead of the information on the operation amount affecting any of the traveling direction and the moving speed.

The biometric information refers to information on the status or variation of, for example, pulse, heartbeat, blood pressure, brain wave, cerebral blood flow, sweating, and facial expression (eyelids, eyebrows, pupils, mouth corners, nasal cavities).

A route selection device 102 is installed in a controller on the vehicle side, calculates switchability to manual driving for each route from a plurality of candidate routes, selects the route with the highest switchability, and outputs the route to a control amount calculation device.

The route selection device 102 includes a database information call unit 103 that acquires information on candidate routes. Here, the route candidate information includes information with which positions of a plurality of route candidates that can reach a destination can be identified. Based on this, data on the host and other vehicles at the time of switching to manual driving in each of the candidate routes in the past is called from the manual driving switching information database 101. The called data includes at least one of the operation information and the biometric information of the user.

If the number of times of acquiring data on the user at the time of switching to manual driving for a candidate route reaches or exceeds a predetermined value, only the information on the user is called (the same applies to the second embodiment and after). This makes it possible to determine the switchability more suitable for the user characteristics (such as driving proficiency level).

A manual driving switchability calculation unit 104 calculates the switchability to manual driving based on the past user operation information or biometric information thus called, selects a route with high switchability, and transmits the result to a traveling control unit. The switchability of the selected route may also be output.

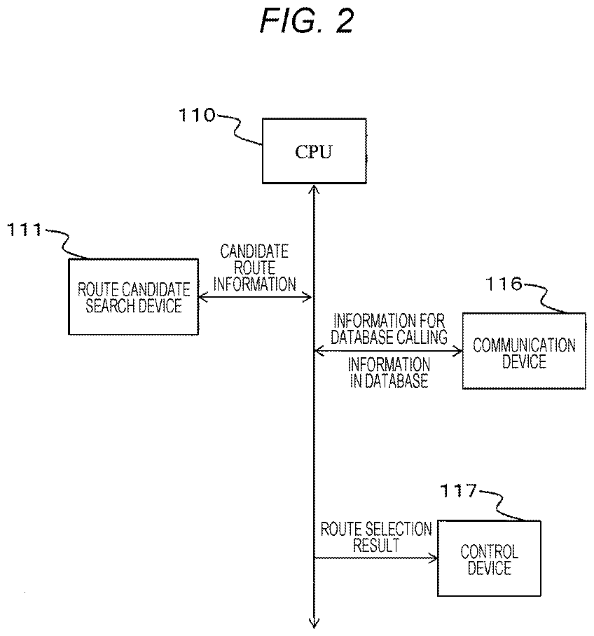

FIG. 2 is a diagram illustrating a configuration of a control device. A CPU 110 calculates the switchability to manual driving for each route, and determines the optimum route. A route candidate search device 111 searches for a plurality of routes with which the destination can be reached from the current host vehicle position based on map information, host vehicle position information, destination information, and the like that are not illustrated. A communication device 116 calls at least one of the past operation information or biometric information on the host vehicle or other vehicles on the candidate route from the manual driving switching information database 101 illustrated in FIG. 1. A control device 117 outputs the route selection result, determined by the CPU 110 based on the called operation information or biometric information, to a control device including a lower level plan system.

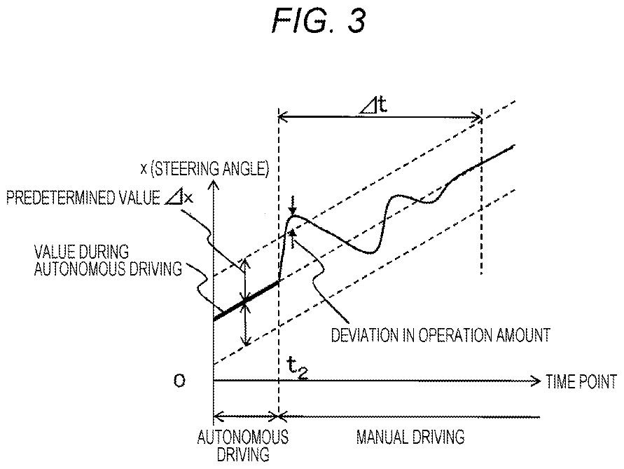

With reference to FIG. 3, the calculation of the switchability will be described. FIG. 3 illustrates steering angles before and after switching from autonomous driving to manual driving in certain past data. The description on the steering angles is given as an example, and the same applies to the accelerator position, the brake depression amount, and the like. At a time point t2, manual control starts with the user moving the steering wheel subjectively. It is illustrated that in a time period until t2, the steering angle increases, indicating that an operation of turning the steering wheel is being performed in the autonomous driving. This is extrapolated after the time point when the manual driving is started, to be compared with the operation amount during the manual driving. If a difference between these amounts reaches or exceeds a predetermined amount Δx within a predetermined time period Δt, it is determined that the switching to the manual driving was performed with low switchability. At the time of route selection, this determination is made on all past data on the route, and a ratio of the number of times that the switchability is determined to be low to the total number of times of switching is calculated for each route. The route with the lowest ratio is selected as the route with the highest switchability.

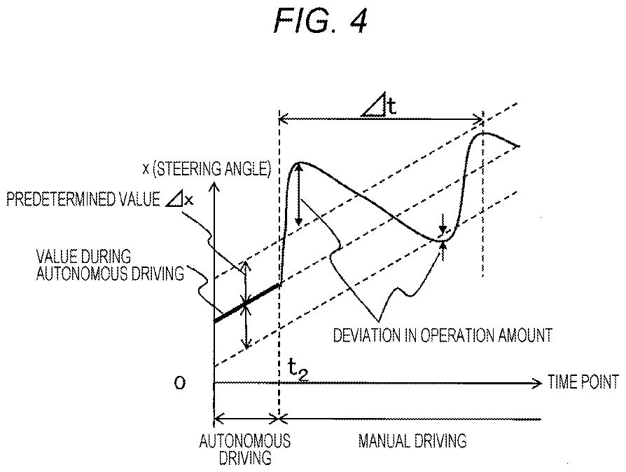

As illustrated in FIG. 4, the switchability may be determined to be low in response to an input of an operation amount deviating at least by the predetermined value Δx on both the positive and negative sides with respect to the autonomous driving operation amount extrapolated, within the time period Δt. As a result, only a hunting of an operation amount due to the user insufficiently recognizing the operation amount can be determined as switching with low switchability, with deviation of the operation amount due to a simple correction of an abnormal operation amount during autonomous driving, immediately before switching to the manual driving, made by the user not determined as such switching. Furthermore, the calculation may be performed by using a difference from the value of the steering angle of the autonomous driving immediately before switching to the manual driving without performing the extrapolation (the same applies to the second embodiment and after).

Also when directly using the values of the travel direction and the moving speed per se instead of the operation amount, the values during autonomous driving before switching to manual driving are extrapolated after the start of the manual driving, and the calculation is similarly performed with the values compared with the traveling direction and the moving speed after the manual driving (the same applies to the second embodiment and after).

When the switchability is calculated by using the values of both the traveling direction and the speed, the calculation may be performed by taking a sum of a difference value of the operation amount related to the traveling direction or the value of the traveling direction itself and a difference value of the operation amount related to the speed or the value of the speed itself (the same applies to the second embodiment and after).

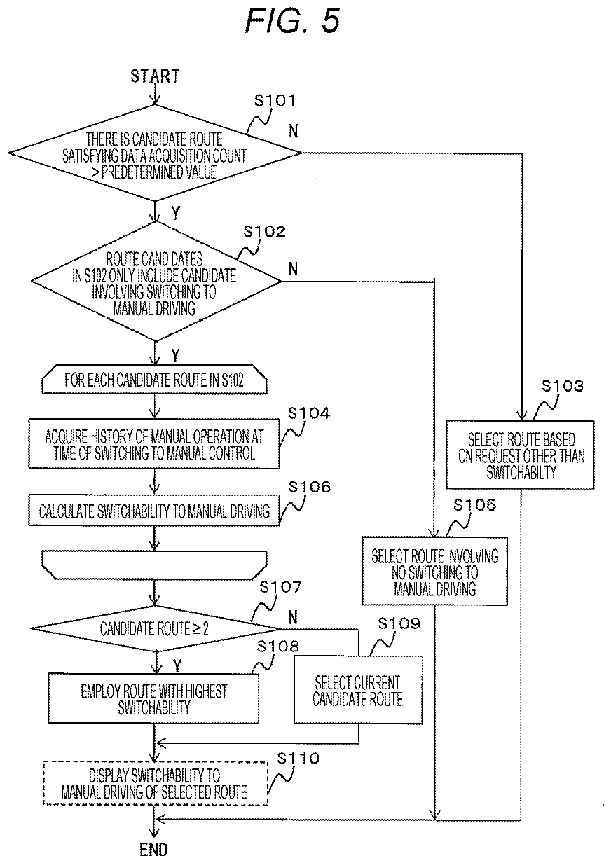

A flow of the embodiment will be described with reference to FIG. 5. First of all, for each of all the candidate routes generated based on the current location, destination, and map information, in S101, a count of data acquisition at the time of switching to the manual driving is acquired from a database, and whether the count reaches or exceeds a predetermined value is determined. The information on the data acquisition count may be stored in a database to be used, or may be calculated from the amount of data in the database when not stored in the database. Preferably, each candidate route is divided at each intersection (node), and the data acquisition count is checked for each divided section (link). Then, it is confirmed that the route as a whole has no node with the data amount being equal to or smaller than a predetermined value.

If there is a candidate route whose data acquisition count reaches or exceeds the predetermined value, the flow proceeds to S102. The flow proceeds to S103 when there is no such candidate route.

In S103, a route is selected based on a requirement other than the switchability. Examples of the requirement other than the switchability include a travel distance, a required time to the destination, and fuel consumption. With this configuration, the route selection can be performed based on the switchability after the manual driving starts, only under a condition that there is a route with a sufficient amount of data due to a sufficient number of vehicles traveling on the route, when the flow proceeds to S102. Thus, the route can be selected with a higher accuracy. More preferably, it is determined whether the data acquisition count within the most recent predetermined period reaches or exceeds a predetermined value. As a result, it is possible to guarantee that the determination reflects the information on the recent road environment (such as a change in the road width, brightness, presence/absence of traffic signals, and presence/absence of construction sites) and the recent traffic environment (such as a traffic volume). Thus, the route can be selected with an even higher accuracy.

In S102, it is checked whether the routes whose data acquisition counts are determined to reach or exceed the predetermined value include any route involving no switching to manual driving. If there is a route in which no vehicle has switched to manual driving within a section between the current location and the destination, the flow proceeds to S105, and is terminated with such a route selected. If any of the routes includes a history of switching to manual driving, the flow proceeds to S104. The calculation in S104 and S106 is performed for each candidate route. In S104, the operation information on the host and other vehicles, at the time of switching to the manual control, in the past on each route is acquired. In S106, the switchability on each route is calculated by the above-described calculation method. When the data acquisition count is calculated for each link, the switchability may be calculated for each link. In this case, the lowest one of values of links included in a candidate route or the weighted average value of switchabilities of the links weighted based on their distances is set as the switchability of the candidate route.

In S104, whether a plurality of the candidate routes are obtained in S102 is determined. If there are a plurality of the candidate routes, the flow proceeds to S108, in which the route with the highest switchability calculated is selected. If there is only one candidate route, selection is not required in the first place. Thus, the flow proceeds to S109 in which the candidate route is selected as a route to travel.

The flow may be terminated at this point, or may be terminated after presenting the switchability to the manual driving on the selected route to the user in S110. A percentage indicating how difficult it is to travel on the route (frequency of occurrence of difficult switching to manual driving) may be displayed. Furthermore, the difficulty may be divided into 100 or fewer stages to be displayed as the levels of difficulty.

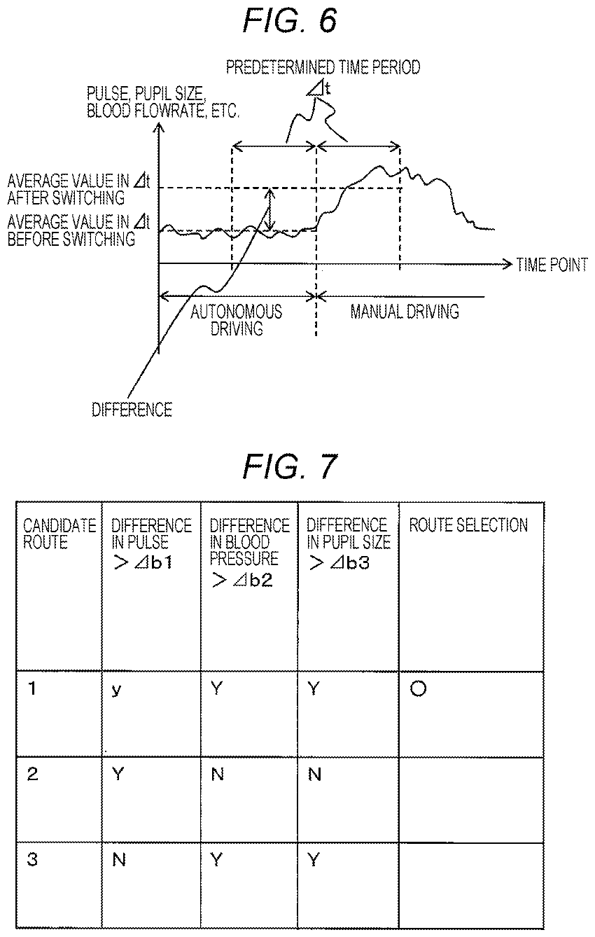

When the determination is made by using the biometric information, the biometric information history at the time of switching to manual control on each route is acquired in S104. Then in S106, of the routes, one with a larger difference between the average value of the biometric information in a predetermined period of time before the switching to the manual control and an average value of the biometric information within a predetermined period of time after the switching is determined as a route with lower switchability. Based on the comparison in magnitudes of the differences, the route with the smallest difference is selected in S108 (FIG. 6). Alternatively, a route with the smallest number of pieces of biometric information with a difference that is equal to or larger than a predetermined value may be selected (FIG. 7).

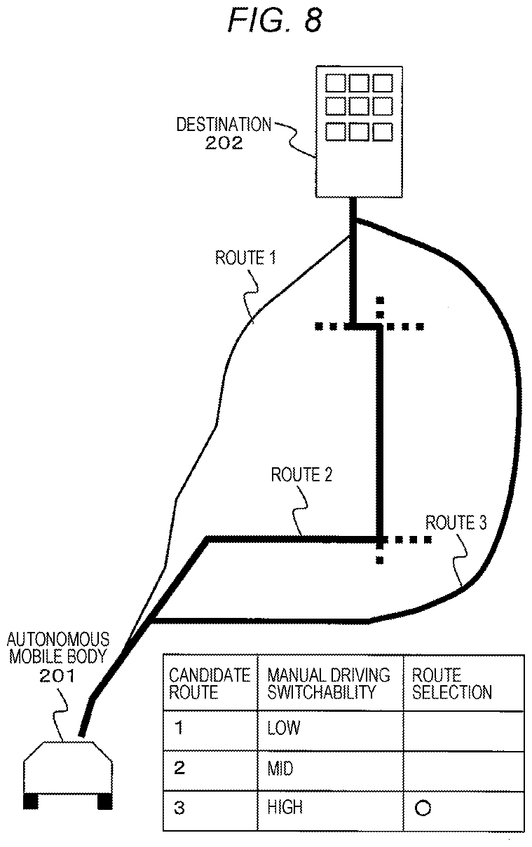

An example of the overall behavior of the embodiment will be described using FIG. 8. There are three route candidates, Route 1 to Route 3, through which an autonomous mobile body 201 can reach a destination 202. Here, Route 1 has the shortest distance but has a narrow road width. Route 2 has the widest road width, but includes many intersections and left and right turns. A result of referring to the manual driving switching information database has indicated that Route 3 has the highest switchability to manual driving. Thus, Route 3 is selected in this system.

The route selection based on the switchability to manual driving may be enabled/disabled based on estimation on the intention or preference of the user, or may be used for route selection in combination with other specifications such as a traveling time and fuel efficiency. Furthermore, when the switchability to manual driving is presented to the user for each route, the user may be able to select a route. Alternatively, if a place where switching to the manual driving is determined to be relatively difficult is unavoidable, the display may be used for alerting the user when the user approaches the place. Furthermore, an allowable lower limit value of the switchability may be set. Thus, when the switchability of the selected route falls below the allowable lower limit value, the user may be notified of this fact to be alerted. Alternatively, the user may be asked whether he/she wants route selection to be performed based on a requirement other than the switchability. When the user wants the route selection to be performed based on a requirement other than the switchability, the route selection in S103 may be performed.

### Second Embodiment

Switchability calculation different from that in the first embodiment will be described. Note that the description of the same configuration as that in the first embodiment is omitted.

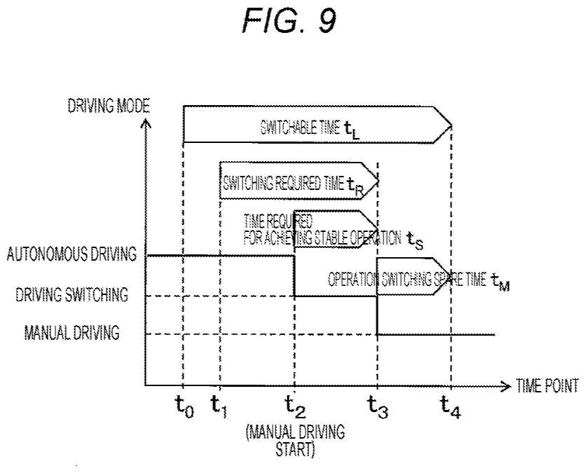

As illustrated in FIG. 9, as the operation information, the database information call unit 103 (see FIG. 1) acquires information that is any one of: a time period tL between a time point t0 at which the system suggests the user to switch to the manual driving and a time point t4 at which the system determines that the switching to the manual driving should be completed; a time period tR between a time point t1 at which the system suggests the user to switch to the manual driving and a time point t3 at which it is determined that the switching is completed (a time point when stable manual driving by the user is achieved, for example); a time period tS between a time point t2 at which the user starts manual operation and t3; and a time period tM between t3 and t4. As in Formula 2 described below, the manual driving switchability calculation unit 104 averages the values of any of tL, tR, tS, and tM and determines the route with the highest switchability through comparison among the average values. Note that switchability is determined to be higher with a longer tL or tM, and is determined to be particularly low when tM is of a negative value. The switchability is determined to be higher with a shorter tR or tS.

### Third Embodiment

Switchability calculation different from that in the first embodiment will be described. Note that the description of the same configuration as that in the first embodiment is omitted.

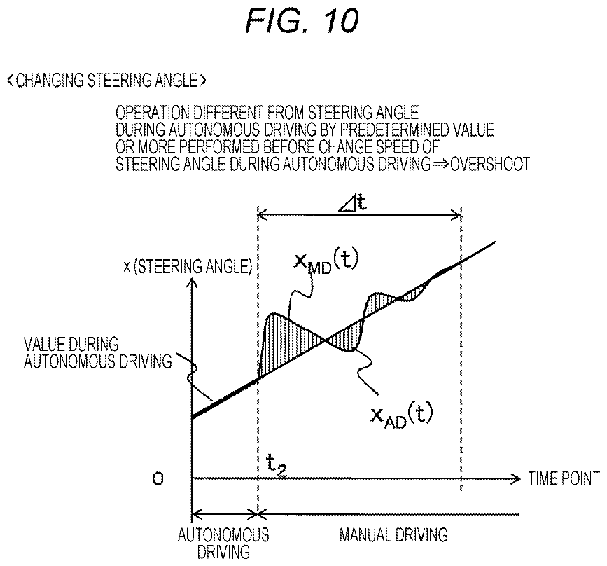

FIG. 10 illustrates steering angles before and after switching from autonomous driving to manual driving in certain past data, as in FIG. 3. At a time point t2, manual control starts with the user moving the steering wheel subjectively. It is illustrated that in a time period until t2, the steering angle increases, indicating that an operation of turning the steering wheel is being performed in the autonomous driving. This is extrapolated after the time point when the manual driving is started, to be compared with the operation amount during the manual driving. A difference (hatched portion in the figure) between the extrapolated operation amount during autonomous driving and the operation amount during manual driving within a predetermined time Δt is calculated by the following Formula.

y=∫ₜ₂^{t2+Δt}|x_{MD}(t)−x_{AD}(t)|dt [Formula 1]

In the Formula, XMD(t) is a manual driving operation amount at a time point t, and XAD(t) is an autonomous driving operation extrapolation amount at the time point t. The values are averaged as follows with respect to past data available (preferably, only data within the most recent predetermined period is used).

$$Y = \frac{1}{N} {\sum }_{n = 1}^{N} {y}_{n} \qquad [ Formula 2 ]$$

In the formula, N is the total number of data pieces on the switching to manual driving included in the available data. Comparison in this value between routes is performed. A route with a larger value is determined to have lower switchability to the manual driving. Thus, more detailed comparison in the degree of instability of operation after the switching can be achieved for each route.

Note that the integration interval is not limited to the predetermined time period Δt, and may be a time period until the time point t3 at which stable operation of manual driving is achieved (refer to FIG. 9 for the time point). The operation may be determined to be stable when the difference from the extrapolated value of the operation amount during the autonomous driving is equal to or smaller than a predetermined value Δx1, or when a variation frequency of the manual driving after start of manual driving becomes equal to or lower than a predetermined value. In this case, the following Formula is used instead of Formula 1.

y=∫ₜ₂^{t3}|x_{MD}(t)−x_{AD}(t)|dt [Formula 3]

Alternatively, the following formula may be used. It should be noted that the formula is usable only when the time point t3, at which stable manual driving is achieved, is earlier than the time point t4 at which the system determines that the switching to the manual driving should be completed.

$$y = \frac{1}{{t}_{3} - {t}_{1}} {\int }_{t 2}^{t 3} \vert {x}_{MD} ( t ) - {x}_{AD} ( t ) \vert dt \qquad [ Formula 4 ]$$

With Formula 4, even if the manual driving is relatively unstable between t2 and t3, switchability of the route can be calculated to be relatively high in a case where the unstableness is due to the start of the manual driving being delayed because the user was looking away (in a case where an interval between t1 and t2 is long, indicating that there was a sufficient time for the switching). If the time point t3, at which stable manual driving is achieved, is later than the time point t4 at which it is determined that the switching should be completed, y is substituted with a sufficiently large value.

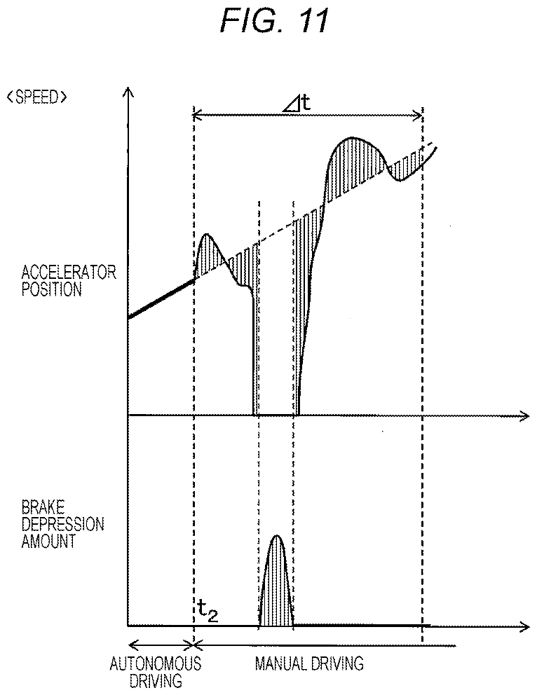

In addition, when user-side interfaces for instructing acceleration and deceleration are separately provided as in the case of automobiles for determining switchability based on the operation amount related to the speed, as illustrated in FIG. 11, difference values are calculated to be integrated and averaged. When the last operation during the autonomous driving is an operation on the accelerator, operation amounts on the brake by the user within a predetermined period of time after the switching to the manual driving may be weighted with a value larger than 1 and summed up. In this case, when the last operation during autonomous driving is an operation on the brake, the same operation is performed for the user's accelerator operation.

y=∫ₜ₂^{t2+Δt}{|x_{MD}(t)−x_{AD}(t)|_{accel}+|x_{MD}(t)|_{brake}}dt [Formula 5]

Formula 5 may be converted into the same format as Formula 3 and Formula 4 to be used.

### Fourth Embodiment

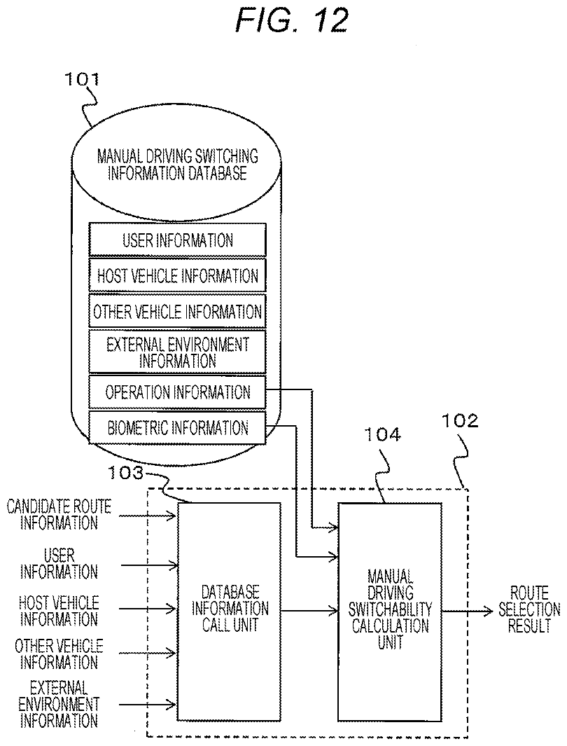

Switchability calculation different from that in the first embodiment will be described. Note that the description of the same configuration as that in the first embodiment is omitted. In the present embodiment, only data close to the user is extracted to be used. In FIG. 12, the manual driving switching information database 101 stores: host vehicle information at the time of occurrence of an event for switching from the autonomous driving to the manual driving (information including: vehicle size class (which may be information that is any one of displacement, wheelbase, body length, and body width); a total traveled distance; a traveled distance or time from the latest inspection; and information on whether the vehicle is a commercial or private vehicle); other vehicle information (relative speed and/or distance with respect to a peripheral vehicle traveling in the same direction, vehicle density, and average speed); external environment information (weather and road condition); and user information (information on age, gender, driving history, and destination on a person operating the vehicle at the time of switching to manual driving).

A route selection device 102 is installed in a controller on the vehicle side, calculates switchability to manual driving for each route from a plurality of candidate routes, selects the route with the highest switchability, and outputs the route to a control amount calculation device.

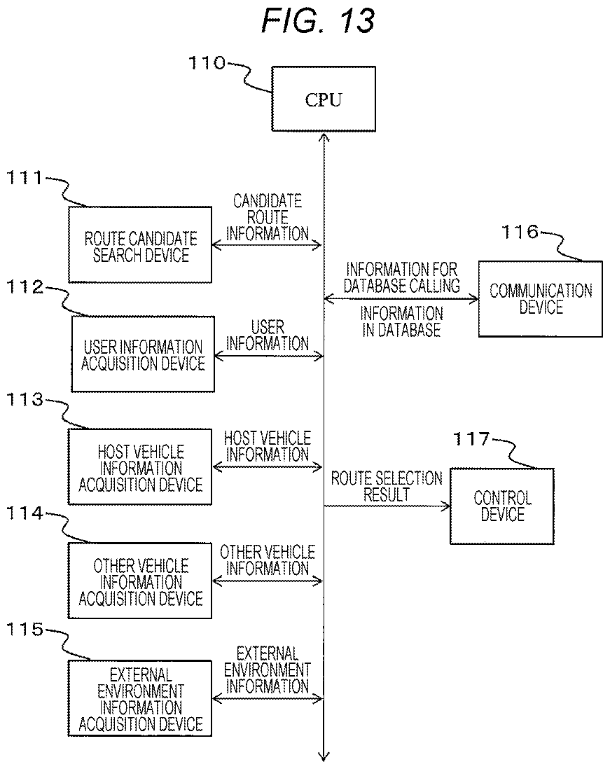

The database information call unit 103 included in the route selection device 102 acquires available user information, host vehicle information, other vehicle information, route information, and external environment information, in addition to the route candidate information. Based on this, data on the host and other vehicles at the time of switching to manual driving in each of the candidate routes in the past, under an environment resembling the current traveling condition of the host vehicle, is called from the manual driving switching information database 101. The called data includes at least one of the operation information and the biometric information of the user. FIG. 13 is a diagram illustrating a configuration of a control device.

With data called with the vehicle information and the user information further used, data at the time of switching to manual driving under a condition with similar host and other vehicle information, external environment information, user information, and route information can be called. As a result, the most suitable route can be selected while further taking individual differences in the vehicle, the external environment, and the user into consideration (good trade-off between efficiency and the sense of security can be found so that the sense of security is not excessively pursued).

### Fifth Embodiment

A description will be given on a method for calculating switchability to manual driving in a device that performs temporary stop at the time of switching to manual driving. This includes autonomous driving with a function to temporarily stop before reaching a location where switching to manual driving is expected and then switching the driving mode due to the intention of the user not to switch to the manual driving during traveling, and an autonomous driving device that performs temporary stop for switching to an operation by a remote operator.

In this device, the switchability to manual driving is determined by evaluating at least one of safe stopping of the autonomous driving and smooth returning to a route after starting manual driving.

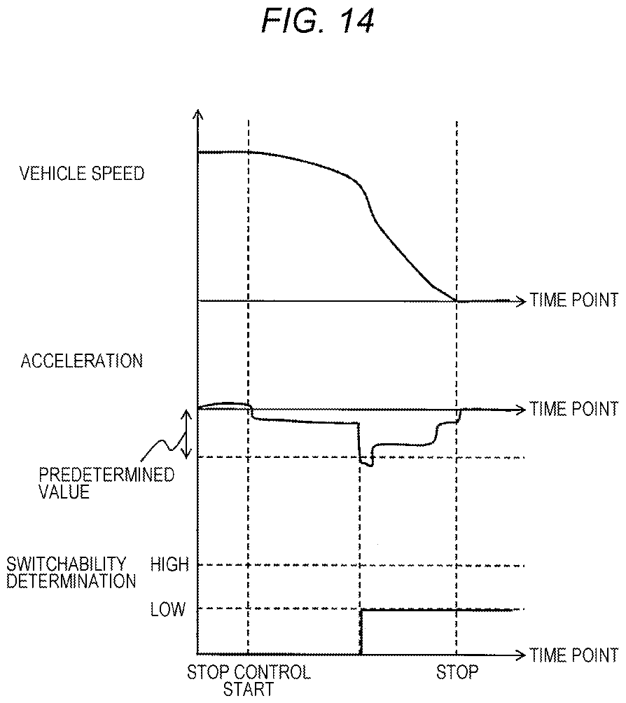

FIG. 14 illustrates an example of a method for determining that autonomous driving has been safely stopped. If the acceleration of a large positive or negative value that is equal to or larger than a predetermined value is detected until the vehicle stops after a time point at which control for stopping starts, it is determined that the vehicle has failed to be stopped safely, and thus the switchability to manual driving is determined to be low. In addition to the acceleration of forward-backward movement, the acceleration of lateral movement and variations of distances from other surrounding vehicles may be used for the determination. Alternatively, the user's biometric information may be acquired, and determination may be made based on whether information indicating the user's tension is obtained.

For example, whether returning to a route was able to be smoothly achieved after the start of the manual driving can be determined as follows. Specifically, a location is determined to be easy to return to the route smoothly when a value of an operation (acceleration in the forward-backward or lateral direction) made by the user within a predetermined period of time elapsed after returning to the original route after the user has started the manual driving is equal to or smaller than a predetermined value, or when no steering of a predetermined value or more is performed in each of the left and right directions (vehicle weaving left and right is unstable behavior). Alternatively, the determination may be made based on the fact that the biometric information does not indicate tension. Alternatively, when a time required for returning to the original route after the manual driving has started is equal to or shorter than a predetermined value (the shorter), the route is determined to be easy to return smoothly (the easier). The timing at which manual driving starts is preferably, for example, a timing at which the gearshift lever is put into drive or a timing at which the blinker is turned ON. Thus, a route can be prevented from being erroneously determined to be difficult to return to, in a case that the user did not attempt to start traveling immediately after the switching to the manual driving due to a certain reason.

The above embodiments can be expressed as follows.

A vehicle control device switches between autonomous driving and manual driving of a vehicle, and includes a first step of obtaining traveling route candidates of the vehicle, a second step of acquiring information that is at least one of information on an operation performed by a user at switching from the autonomous driving to the manual driving and biometric information on the user, and a third step of selecting a traveling route of the vehicle based on the information acquired in the second step.

As the information on the operation performed by the user when switching from the autonomous driving to the manual driving, information is used that is at least one of an operation that affects any of a traveling direction and moving speed of the vehicle and time required for the switching from the autonomous driving to the manual driving to be completed.

The traveling route of the vehicle is selected with switchability to the manual driving calculated for each of the traveling route candidates by using at least one of the information on the operation performed by the user at switching from the autonomous driving to the manual driving and the biometric information on the user.

The traveling route of the vehicle is selected with switchability to the manual driving calculated by acquiring at least one of information on the vehicle, information on a peripheral vehicle, information on an external environment, and the biometric information on the user, and by referring to past information corresponding to the information acquired.

The switchability selected is displayed to the user.

Whether the traveling route selected based on the switchability is effective or ineffective is selected based on an input from the user or a result of estimating preference of the user.

The traveling route is selected based on the switchability in combination with priority of a traveling time or fuel efficiency of the vehicle.

The switchability of each of the traveling routes is presented to the user in a selectable state.

The user is alerted before entering a location where the switchability is low.

A route with a smaller amount of operation performed by the user when switching from the autonomous driving to the manual driving and smaller variation of the biometric information on the user, or with any one of the amount of the operation, the variation of the biometric information, and time required for returning to the traveling route in a case that the vehicle stops after temporarily deviating from the traveling route and then returns to the traveling route with the manual driving being smaller or shorter is determined to be a route the switchability of which is higher.

As described above, it is possible to select a route with less burden of switching to manual driving based on the operation information or the biometric information of the user at switching from autonomous driving to manual driving. With this configuration, even if there is no route available that involves no switching to manual driving in candidate routes, the user can use the autonomous driving system with the sense of security without being nervous about the switching to manual operation.

1. A vehicle control device that switches between autonomous driving and manual driving of a vehicle, the vehicle control device comprising:
a first step of obtaining traveling route candidates of the vehicle;
a second step of acquiring information that is at least one of information on an operation performed by a user at switching from the autonomous driving to the manual driving and biometric information on the user; and
a third step of selecting a traveling route of the vehicle based on the information acquired in the second step.

2. The vehicle control device according to claim 1, wherein as the information on the operation performed by the user when switching from the autonomous driving to the manual driving, information is used that is at least one of an operation that affects any of a traveling direction and moving speed of the vehicle and time required for the switching from the autonomous driving to the manual driving to be completed.

3. The vehicle control device according to claim 1, wherein the traveling route of the vehicle is selected with switchability to the manual driving calculated for each of the traveling route candidates by using at least one of the information on the operation performed by the user at switching from the autonomous driving to the manual driving and the biometric information on the user.

4. The vehicle control device according to claim 1, wherein the traveling route of the vehicle is selected with switchability to the manual driving calculated by acquiring at least one of information on the vehicle, information on a peripheral vehicle, information on an external environment, and the biometric information on the user, and by referring to past information corresponding to the information acquired.

5. The vehicle control device according to claim 3, wherein the switchability selected is displayed to the user.

6. The vehicle control device according to claim 3, wherein whether the traveling route selected based on the switchability is effective or ineffective is selected based on an input from the user or a result of estimating preference of the user.

7. The vehicle control device according to claim 3, wherein the traveling route is selected based on the switchability in combination with priority of a traveling time or fuel efficiency of the vehicle.

8. The vehicle control device according to claim 3, wherein the switchability of each of the traveling routes is presented to the user in a selectable state.

9. The vehicle control device according to claim 3, wherein the user is alerted before entering a location where the switchability is low.

10. The vehicle control device according to claim 3, wherein a route with a smaller amount of the operation performed by the user when switching from the autonomous driving to the manual driving and smaller variation of the biometric information on the user, or with any one of the amount of the operation, the variation of the biometric information, and time required for returning to the traveling route in a case that the vehicle stops after temporarily deviating from the traveling route and then returns to the traveling route with the manual driving being smaller or shorter is determined to be a route the switchability of which is higher.
